(19) United States
(12) Patent Application Publication
(10) Pub. No.: US 2007/0295804 A1
(43) Pub. Date: Dec. 27, 2007

(54) Machine for checking all your bank transactions and process them into handheld electronic device

(76) Inventors: Ralston Alphanso Garvey JR., St. Petersburg, FL (US); Darryl Lamar Wilson JR., St. Petersburg, FL (US)

Correspondence Address: Ralston Garvey Jr., 4643 20 Ave. So, St. Petersburg, FL, 33711, US

(21) Appl. No.: 11/800,195

(22) Filed: May 4, 2007

Related U.S. Application Data
(60) Provisional application No. 60/816,509, filed on Jun. 26, 2006.

(51) Int. Cl. G07F 19/00; G06Q 40/00

(52) U.S. Cl. 235/379; 705/64

(57) ABSTRACT

Imagine a machine that allows you to view all bank transactions in addition to giving you the ability to check your balance, make payments, and transfer money into different accounts, in the palm of your hand. All these options are accessible through the said device. The disclosed electronic device has an embodied display screen for viewing account activity as well as merchant information, and any deposits made. It also has primary acquisition alert, in addition to having pin code or finger print recognition.

### CROSS REFERENCE TO RELATED APPLICATIONS

This is a continuation of Ser. No. 60/816,509, filed on Jun. 26, 2006, and is also based on provisional application Ser. No. 60/816,509, filed on Jun. 26, 2006.

### STATEMENT REGARDING FEDERALLY SPONSORED RESEARCH OR DEVELOPMENT

Not Applicable

### DESCRIPTION OF ATTACHED APPENDIX

Insert Description of Attached Appendix here.

### BACKGROUND OF THE INVENTION

This invention relates generally to the field of banking and more specifically to a machine for checking all your bank transactions and process them into handheld electronic device. The major disadvantage of using modern debit cards is that they might not offer you the financial protection that the said electronic device does regarding fraud. If the said device is stolen, you will only be required to report it lost or stolen. However, if your debit card is stolen, a thief can use it at many locations without being required to have access to a PIN number. Money lost from your bank account in this manner is not refundable. And thieves don't have to have your actual card. If they acquire your number, they can drain your checking account entirely. However, with said electronic device an I.D. code or fingerprint recognition is required to view all information, transactions and make functional of the said device.

### BRIEF SUMMARY OF THE INVENTION

The primary object of the invention is to make normal debit and credit transactions.

Another object of the invention is see updated balance of users accounts.

Another object of the invention is Transfer money to different accounts from the palm of your hand.

A further object of the invention is Pay monthly payment out the palm of your hand.

Yet another object of the invention is Updated balance after every purchase.

Still yet another object of the invention is Have to enter security I.D. before every purchase.

Another object of the invention is Choice which account you would like to use out the palm of your hand.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for checking all your bank transactions comprising: Scroll key to activate all accounts and transactions, LCD screen displays all info, and device has primary acquisition alert.

In accordance with a preferred embodiment of the invention, there is disclosed a process for checking all your bank transactions and making purchases comprising the steps of: Scroll key or finger print recognition to activate security I.D. system, Magnetic strip release button is time linked, Read dumb terminal amount, Write dumb terminal amount, Scroll key to activate all accounts, LCD screen displays all info, and device has primary acquisition alert.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An electronic device for conducting wireless debit/credit transactions comprising: a mitt card designed to work as a conventional credit/debit card with the additional capabilities of primary purchase alert and electronic data storage, and wireless handheld data transmission with usb connection capabilities to home computer

1. The electronic device of claim 1, wherein said term mitt card refers to a debit/credit card with electronic wireless capabilities for transmitting financial data between card owner and financial institution

2. The electronic device of claim 1, wherein said primary purchase alert detects all bank transactions.

3. The electronic device of claim 1, wherein said electronic data storage is incorporated in the said electronic device.

4. The electronic device of claim 1, wherein said data transmission is incorporated in the said electronic device.

5. The electronic device of claim 1, wherein said mitt card in compliance with device is further configured to store addresses of said addressable parties.

6. The electronic device of claim 1, wherein said mitt card is further configured to be accessible by use of personal identification numbers or fingerprint recognition.

7. The electronic device of claim 1, wherein said mitt card is configured to receive a signal representing an electronic receipt for a payment made by said device and transfer details of said electronic receipt to said device, and said mitt card further functions as a storage device for storing said electronic returns.

8. The electronic device of claim 1, wherein said mitt card further comprises an encryption algorithm and said mitt card is configured to transmit encrypted signal.

9. The electronic device of claim 1, wherein said magnetic strip will be retracted into device after each transaction and a code must be entered or fingerprint recognition on device by owner touch screen or scroll key to eject magnetic strip from the device for use in a debit/credit transactions.

10. Design of device with finger indentations for a enhanced grip.

11. Device will incorporate time activated off control and a on activated security code feature.

12. Device automatically turns off after a certain amount of time but override if financial communications and updates are being sent or received

13. Device replaceable silver oxide battery in easily accessible location for easy consumer replacement or rechargeable battery system.

14. Card will have ability to access on line bank account and complete bill paying and see up to date online information.
